(19) United States
(12) Patent Application Publication
(10) Pub. No.: US 2010/0010780 A1
(43) Pub. Date: Jan. 14, 2010

(54) Method for signal denoising using continuous wavelet transform

(75) Inventor: Hailong Zhu, Kowloon (CN)

Correspondence Address: KAUTH , POMEROY , PECK & BAILEY ,LLP, 2875 MICHELLE DRIVE, SUITE 110, IRVINE, CA, 92606, US

(73) Assignee: The Hong Kong Polytechnic University, Hong Kong (HK)

(21) Appl. No.: 12/216,719

(22) Filed: Jul. 10, 2008

(51) Int. Cl. H04B 15/00

(52) U.S. Cl. 702/191

(57) ABSTRACT

The present invention relates to a novel method for signal denoising utilizing a continuous wavelet transform. The method preferably utilizes derivatives of Gaussian functions.

### BACKGROUND

Systems accepting signals have frequently employed denoising methods to improve the quality of the received signals. Current systems utilize wavelet techniques for denoising received wavelets. Wavelet theory involves representing general functions in terms of simpler fixed building blocks at different scales and positions in time. An explanation of wavelet transformation can be found at Canadian Patent No. 2473620.

However, current systems utilizing wavelet techniques for denoising are based on maximally-decimated discrete wavelet transform. The denoising thus results in undesirable artifacts, such as the pseudo-Gibbs phenomenona in the neighborhood of discontinuities.

It is an object of the present invention to overcome the disadvantages and problems in the prior art.

### DESCRIPTION

The present invention relates to a novel method for signal denoising utilizing a continuous wavelet transform. The method preferably utilizes derivatives of Gaussian functions.

These and other features, aspects, and advantages of the apparatus and methods of the present invention will become better understood from the following description, appended claims, and accompanying drawings where:

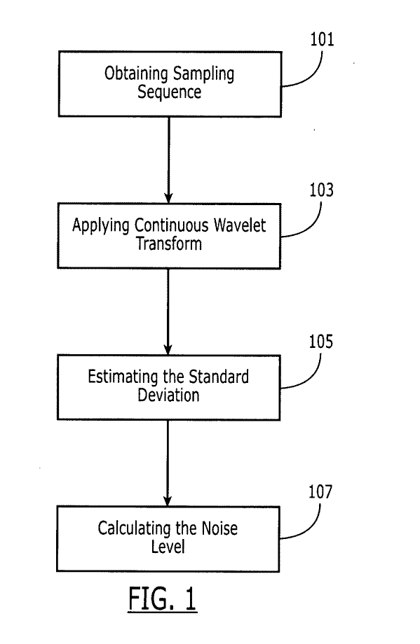

FIG. 1 exhibits a method of estimating the threshold δₛ necessary for the present invention;

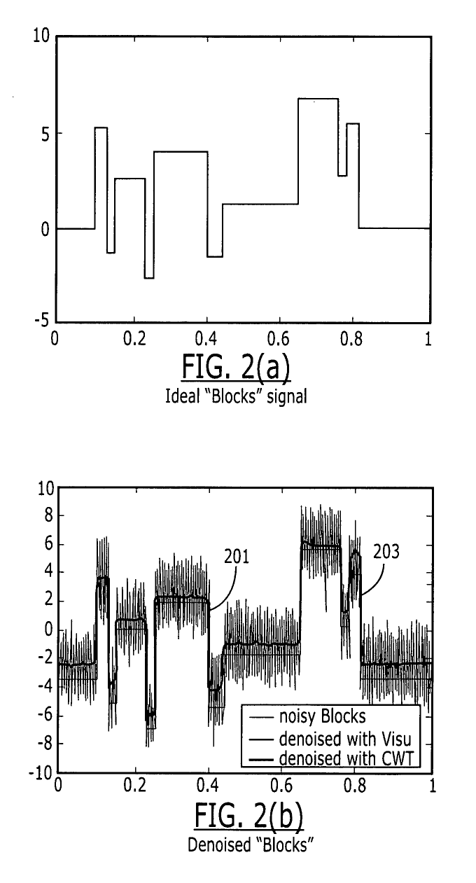

FIG. 2 exhibits the present method of applied to block signals;

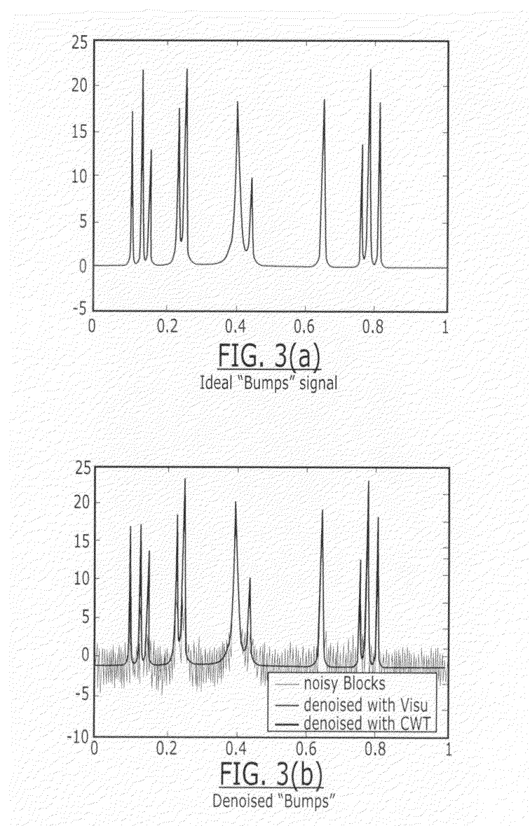

FIG. 3 exhibits the present method applied to bump signals;

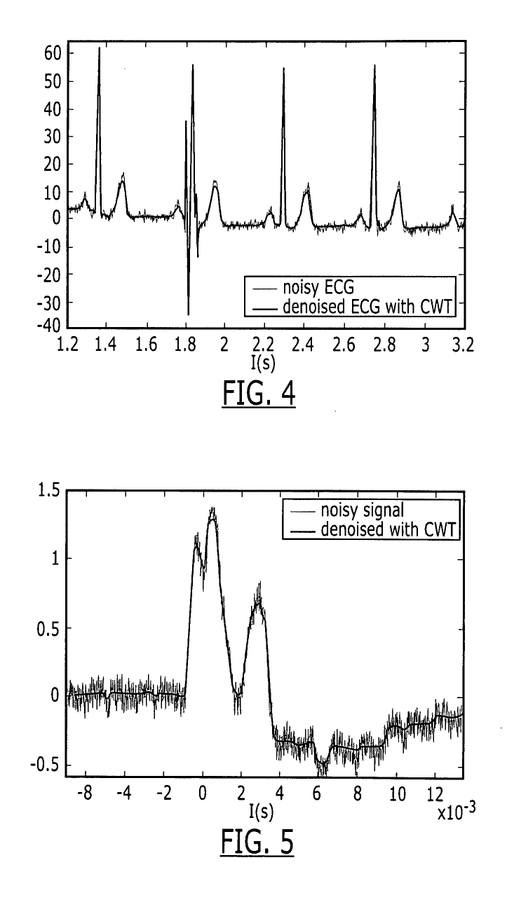

FIG. 4 exhibits the present method applied to an ECG signal;

FIG. 5 exhibits the present method as applied to ultrasound signals; and

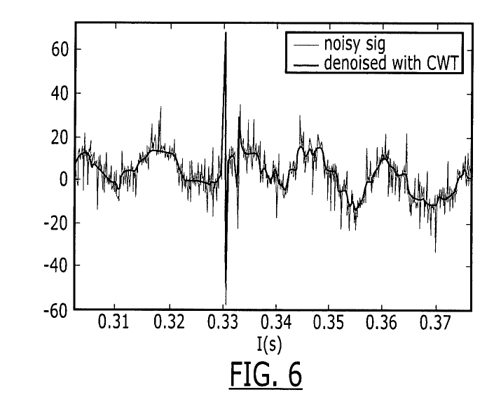

FIG. 6 exhibits the present method as applied to sound signals.

The following description of certain exemplary embodiment(s) is merely exemplary in nature and is in no way intended to limit the invention, its application, or uses. Throughout this description, the term “sampling” shall refer to reduction of a continuous signal to a discrete signal.

Now, to FIGS. 1-6,

FIG. 1 is an embodiment of a method for estimating the threshold δₛ; a thresholding process is performed to remove or reduce noisy wavelet coefficients, necessary for the present invention.

Firstly, a sampling sequence of background noise is obtained 101. In an alternative embodiment, a noise sequence is generated. In one embodiment, for obtaining a sampling sequence only the additive noise is considered y=Θ+u, where u, the background noise, is additive to Θ the signal, and there is no coupling term. Sampling can occur through both hardware and software components, and derived from Θ signals, for example biomedical signals, such as electrocardiogram, electromyography, electroencephalography, mechanomyogram, vibration signals, acoustic signals, distance/time measurement signals, displacement signals, speech signals, electronic signals, ultrasound signals, etc. Θ can be delivered to one of a number of instruments such as machines, for example, compressors, pumps, engines, turbines, airfoil, electronic machines, robots, etc., transportation, for example, aircraft, rockets, marine vehicles, trains, automobiles, motorcycles, etc., mechanical components, for example, gears, springs, ropes, wheels, axels, bearings, belts, seals, roller chains, link chains, rack and pinions, fasteners, keys, etc., and structures, for example, buildings, bridges, tunnels, highways, railways, etc.

A continuous wavelet transform (CWT) is then applied to the sampling sequence 103. The CWT useful for the present invention includes translate-invariant transformation; CWT can be selected from continuous wavelets selected from the group consisting of Marlet, Modified Marlet, Mexican hat, Complex Mexican hat, Shannon, Derivatives of Gaussian (DOGs), Hermitian, Hermitian hat, Beta, Causal, u, Couchy, and Addison. Preferably, the wavelet is Derivatives of Gaussian, for example

$${ψ}_{0} ( η ) = \frac{{( - 1 )}^{m - 1}}{\sqrt{Γ ( m + \frac{1}{2} )}} \frac{{d}^{m}}{d {η}^{m}} ( {e}^{- {η}^{2} / 2} )$$

In performing continuous wavelet transform, the continuous scale space is digitized to be a scale set
S={sⱼ, j=0,1 . . . , J} with each element sⱼ to be a fractional power of two:

Sⱼ=s₀2^{jδi}, and J=δⱼ⁻¹ log 2(Nδᵢ/s₀)

where sₒ is the smallest scale, δₛ determines the resolution of frequency, and J is the index of the largest scale. To make sure the scaled wavelet function has unit energy, following normalization is imposed:

$$\hat{ψ} ( s {ω}_{k} ) = {( \frac{2 π s}{{δ}_{i}} )}^{1 / 2} {\hat{ψ}}_{0} ( s {ω}_{k} )$$

The continuous wavelet transform at scale s of signal xₙ is written as

$${W}_{n} ( s ) = {\sum }_{k = 0}^{N - 1} {\hat{x}}_{k} {\hat{ψ}}^{m} ( s {ω}_{k} ) {e}^{{iω}_{k} n {δ}_{t}}$$

Where \hat{x}ₖ is the Fourier transform of the signal xₙ
Signal denoising performed by continuous wavelet transform is performed by thresholding process T on each scale of wavelet coefficients to obtain the shrinked wavelet coefficients Wₙ^{T}(s). Any thresholding process that can remove or reduce the noisy wavelet coefficients can be applied, for example, soft thresholding, hard thresholding, or Bayes approach thresholding. In a particular embodiment, soft thresholding is used:

Wₙ^{T}(s)=sgn(Wₙ(s))( |Wₙ(s)|−δₛ)

where δₛ is the threshold of coefficient at scale s, and (y), means

$${( y )}_{+} = \{ \begin{matrix}y , & if y > 0 \\ 0 , & if y \leq 0\end{matrix}$$

with the thresholding wavelet coefficients Wₙ(s), the denoised signal is obtained by

$${\tilde{x}}_{n}^{d} = {\sum }_{x ∈ S} ( {\sum }_{k = 0}^{N - 1} {\hat{W}}_{k}^{T} ( s ) {\hat{ϕ}}^{*} ( s {ω}_{k} ) {e}^{{iω}_{k} n δ} )$$

The standard deviation of wavelet coefficients at all scales, i.e., Γₛ is then estimated 105.

Calculating the noise level at all scales by

δₛ=σₛ\sqrt{2 log N}

where N is the number of sampling points 107.

Through the present invention, a sampling-based approach is designed. Thus, assuming background noise to be Gaussian White noise (GWN) can be avoided. The denoised signal of the present method enjoys a high accuracy in terms in signal-to-noise ratio. The denoised signal is generally smoother than traditional methods based on translate-variant discrete wavelet transforms because the present method is based on translate-invariant continuous wavelet transform.

The present method can be integrated into any software of signal acquisition or analysis. The method, in the form of a coded algorithm, can be implemented in hardware to develop signal denoising circuits or chips.

FIG. 2 exhibits an example from the present method. (a) shows “block” signals and denoising results. In (b), the dotted line is the denoised signal of the prior art 201, the solid line is the denoised signal of the present method 203.

FIG. 3 exhibits a further example of the present method. (a) shows “bump” signals; in (b), the dotted line is the denoised signal of the prior art, and the solid line is the denoised signal of the present method.

FIG. 4 shows the present method as applied to ECG signals.

FIG. 5 shows the present method as applied to an ultrasound signal.

FIG. 6 shows the present method as applied to a sound signal.

Having described embodiments of the present system with reference to the accompanying drawings, it is to be understood that the present system is not limited to the precise embodiments, and that various changes and modifications may be effected therein by one having ordinary skill in the art without departing from the scope or spirit as defined in the appended claims.

In interpreting the appended claims, it should be understood that:

a) the word “comprising” does not exclude the presence of other elements or acts than those listed in the given claim;

b) the word “a” or “an” preceding an element does not exclude the presence of a plurality of such elements;

c) any reference signs in the claims do not limit their scope;

d) any of the disclosed devices or portions thereof may be combined together or separated into further portions unless specifically stated otherwise; and

e) no specific sequence of acts or steps is intended to be required unless specifically indicated.

1. A method for signal denoising comprising the steps:
obtaining a sampling sequence of a background noise;
applying a continuous wavelet transform (CWT) to said sampling sequence; and
obtaining a denoise signal through the function
$${\tilde{x}}_{n}^{d} = {\sum }_{x ∈ S} ( {\sum }_{k = 0}^{N - 1} {\hat{W}}_{k}^{T} ( s ) {\hat{ϕ}}^{*} ( s {ω}_{k} ) {e}^{{iω}_{k} n δ} )$$

2. The method for signal denoising of claim 1, wherein obtaining said sampling sequence occurs through hardware or software components.

3. The method for signal denoising of claim 2, wherein said sampling sequence is selected from the group consisting of electrocardiogram, electromyography, electroencephalography, mechanomyogram, vibration signals, acoustic signals, distance/time measurement signals, displacement signals, speech signals, electronic signals, and ultrasound signals.

4. The method for signal denoising of claim 1, wherein only additive noise represented by u in the function
y=Θ+u
is considered for obtaining said sampling sequence.

5. The method for signal denoising of claim 1, wherein said continuous wavelet transform is selected from the group consisting of translate-invariant Marlet, Modified Marlet, Mexican hat, Complex Mexican hat, Shannon, Derivatives of Gaussian, Hermitian, Hermitian hat, Beta, Causal, u, Couchy, and Addison.

6. The method for signal denoising of claim 5, wherein said continuous wavelet transform is Derivatives of Gaussian.

7. The method for signal denoising of claim 1, wherein applying a continuous wavelet transform occurs by performing a thresholding process such as soft thresholding, hard thresholding, or Bayes approach thresholding.

8. The method for signal denoising of claim 7, wherein performing said thresholding process results in shrinked wavelet coefficients Wₙ^{T}(s).

9. The method for signal denoising of claim 8, wherein performing said thresholding process occurs by soft thresholding utilizing the function:
Wₙ^{T}(s)=sgn(Wₙ(s))( |Wₙ(s)|−δₛ)

10. The method for signal denoising of claim 1, whereby such method occurs on signal denoising circuits.
